(19) United States
(12) Patent Application Publication
(10) Pub. No.: US 2013/0242308 A1
(43) Pub. Date: Sep. 19, 2013

(54) Device for Reading Assay Results on Test Carrier

(71) Applicants: Ying'an Zhan, Hangzhou (CN); Wei Liu, Hangzhou (CN); Yinfei Wu, Hangzhou (CN); Fei Gao, Hangzhou (CN)

(72) Inventors: Ying'an Zhan, Hangzhou (CN); Wei Liu, Hangzhou (CN); Yinfei Wu, Hangzhou (CN); Fei Gao, Hangzhou (CN)

(73) Assignee: ABON Biopharm (Hangzhou)Co., Ltd., Hangzhou ,Zhejiang (CN)

(21) Appl. No.: 13/822,147

(22) PCT Filed: Sep. 2, 2011
(86) PCT No.: PCT/CN2011/079274

§ 371 Date: May 29, 2013

(30) Foreign Application Priority Data
Sep. 9, 2010 (JP) 201010280225.9

(51) Int. Cl. G01N 21/55

(52) U.S. Cl. CPC G01N 21/553
USPC 356/445

(57) ABSTRACT

A device for reading an assay test result on a test carrier comprises: a light-emitting element (5) for emitting and irradiating light onto corresponding one or more zones of the test carrier (3); a light-blocking element (12) for blocking the light mirror-reflected by the test carrier (3) from being irradiated on a photodetector (7); and a window (10), through which the light emitted from the light-emitting element (5) is irradiated onto the corresponding zones of the test carrier (3). In one preferred embodiment, the positions of the light-emitting element (5), the light-blocking element and the window (10) meet the function of S3≦>2*S7−S7*S2/S1, where S1 represents the vertical distance between the light-emitting element and the window; S2 represents the vertical height of the light-blocking element; S3 represents the vertical distance between the light-blocking element and the light-emitting element; and S7 represents the length of the window.

### CROSS REFERENCE TO RELATED ART

This application claims the benefit of priority to Chinese Patent Application No. 201010280225.9, entitled “DEVICE FOR READING ASSAY RESULTS ON TEST CARRIER”, filed on Sep. 9, 2010 with State Intellectual Property Office of PRC, which is incorporated herein by reference in its entirety.

### FIELD OF THE INVENTION

The present invention relates to assay reading devices for the measurement of analytes. In particular, the present invention relates to electronic readers for use with assay test-strips which use optical methods.

### BACKGROUND OF THE INVENTION

Analytical devices suitable for home testing of analytes are now widely commercially available. A lateral flow immunoassay device suitable for the measurement of the pregnancy hormone human chorionic gonadotropin (hCG) is sold by Unipath under the brand-name CLEARBLUE® and is disclosed in EP291194.

EP291194 discloses an immunoassay device, which includes a water-permeable porous carrier containing a particulate labelled specific binding reagent for an analyte, which reagent is freely mobile when in the moist state; and an unlabelled specific binding reagent for the same analyte, which reagent is immobilised in a detection zone or test zone downstream from the unlabelled specific binding reagent. Liquid sample suspected of containing analyte is applied to the porous carrier whereupon it interacts with the particulate labelled binding reagent to form an analyte-binding partner complex. The particulate label is coloured and is typically gold or a dyed polymer, for example latex or polyurethane. The complex thereafter migrates into a detection zone whereupon it forms a further complex with the immobilised unlabelled specific binding reagent enabling the extent of analyte present to be detected or observed.

Various methods of timing the result have been proposed for commercial devices, including instructions to the user wait for a particular length of time before reading the assay result. Other methods include a signal that is generated after a particular period of time has elapsed, as disclosed in co-pending application No. PCT/EP03/00274, which signal informs the user that the assay result should now be read.

Electronic readers for use in combination with test carriers such as assay test-strips for determining the concentration and/or amount of analyte in a fluid sample are known. EP653625 discloses such a device which uses an optical method in order to determine the result. An assay test strip such as that disclosed in EP291194 is inserted into a reader such that the strip is aligned with optics present within the reader. Light from a light source, such as a light emitting diode (LED), is shone onto the test strip and either reflected or transmitted light is detected by a photodetector. Typically, the reader will have more than one LED, and a corresponding photodetector is provided for each of the plurality of LEDs.

U.S. Pat. No. 5,580,794 discloses a fully disposable integrated assay reader and lateral flow assay test strip whereby optics present in the reader enable the result to be determined optically using reflectance measurements.

However, there are a lot of problems existing in the above disclosed devices when it is desired that final results can be sensitively read in spite of the varied signal in the detecting zone of the analysis test strip. When light emitted from multiple light emitting elements is irradiated on a corresponding zone in a narrow test strip, it is desired that the light reflected or transmitted from the zone will be irradiated onto one or more specific photodetectors as much as possible, but not onto undesired photodetectors, so as to ensure the accuracy of the detecting. Furthermore, in practical use, it is desired that the light irradiated onto the photodetectors can reflect the variation of signals in the testing zone as much as possible, while avoiding the interference of undesired light with the measured results.

U.S. Pat. No. 7,315,378 provided a method which involves in disposing baffles between the light-emitting elements and the photodetectors, so that the light emitted from the light-emitting elements can be prevented from being directly irradiated on the photodetectors, thereby preventing the final reading results from being inaccurate. However, there are still needs for improving the device for reading the test result on a testing strip using an optical system. In particular, there are needs for a photodetector which can accurately reflect the variation of signals in a specific testing zone and be free of any interference from the light reflected from other non-testing zones, when multiple assays having different test results are performed on one testing strip simultaneously. In addition, it is necessary to obtain accurate readings for each of the testing zones.

For providing a more accurate and reliable device, some additional technical features are preferably used, which can eliminate the undesired light from the testing strip at the most and enable the photodetector to detect the light directly reflecting the testing sample in corresponding zone on the test carrier at the most. Furthermore, it is preferable to eliminate the interference with the photodetector caused by the undesired light from other non-test strip/test carrier elements.

### SUMMARY OF THE INVENTION

The present invention provides a device capable of avoiding the interference of the undesired light with the photodetector, and irradiating the light reflected or transmitted from the assay strip or the test carrier onto the photodetector as much as possible; and especially enabling the photodetector to detect the light effectively reflected or transmitted from the test carrier and reflecting the variation of the signals in the detecting zones and/or controlled zones, while avoiding the influence from undesired light. Generally, when performing an assay by using liquid-delivering carrier, the liquid sample is first applied on the carrier, and the assay result is read by using a reading device. In one preferred example, the assay result is read by using an optical system.

In one aspect, the present invention provides a device for reading a test result on a test carrier, including: a light-emitting element for emitting and irradiating light onto corresponding one or more zones of the test carrier; and a blocking element for blocking the light mirror-reflected by the test carrier or non-test carrier from being irradiated on a photodetector. In one preferred embodiment, the blocking element is a light-blocking element for blocking the light mirror-reflected by the test carrier from being irradiated onto the photodetector. In another preferred embodiment, the blocking element is a sloping surface for blocking the light mirror-reflected from the non-test carrier from being irradiated onto the photodetector.

In one embodiment, the device includes a photodetector receiving the light reflected or transmitted from the corresponding zones on the test carrier.

In another preferred embodiment, the light-blocking element is positioned in an area in which the light emitted from the light-emitting element is irradiated and mirror reflection is occurred on the test carrier. In this way, part or all of the light mirror-reflected from the test carrier can be blocked and will not be detected by the photodetector, and inaccurate reading for the assay result on the test carrier can be avoided.

In another preferred embodiment, the device can further include a window through which the light emitted from the light-emitting element is irradiated onto the test carrier, where the positions of the light-emitting element, the light-blocking element and the window meet the function of

$$S 3 ≧ \frac{S 7}{S 1} \times ( 2 \times S 1 - S 2 ) ,$$

where S1 represents the vertical distance between the light-emitting element and the window; S2 represents the vertical height of the light-blocking element; S3 represents the vertical distance between the light-blocking element and the light-emitting element; and S7 represents the length of the window. In this way, the light mirror-reflected from the testing strip can be effectively prevented from being irradiated onto the photodetector, thereby reducing the interference of the mirror-reflected light with the final test result. In one preferred embodiment, the positions of the light-emitting element, the light-blocking element and the window meet the function of

$$S 3 = \frac{S 7}{S 1} \times ( 2 \times S 1 - S 2 ) .$$

In another aspect, the present invention provides a device for reading a test result on a test carrier, including: a test carrier, including one or more zones; a light-emitting element for emitting and irradiating light onto corresponding one or more zones of the test carrier; and a light-blocking element for blocking the light mirror-reflected by the test carrier from being irradiated onto a photodetector. In some embodiments, the positions of the light-emitting element, the light-blocking element and the zone(s) on the test carrier meet the function of

$$S 3 ≧ \frac{S 7}{S 1} \times ( 2 \times S 1 - S 2 ) ,$$

where S1 represents the vertical distance between the light-emitting element and the zone(s) on the test carrier; S2 represents the vertical height of the light-blocking element; S3 represents the vertical distance between the light-blocking element and the light-emitting element; and S7 represents the length of an energized light zone formed by the light emitted from the light-emitting element and irradiated on the test carrier. Preferably, the positions of the light-emitting element, the light-blocking element and the zone(s) on the test carrier meet the function of

$$S 3 = \frac{S 7}{S 1} \times ( 2 \times S 1 - S 2 ) .$$

In another aspect, the present invention provides a device for reading a test result on a test carrier, including: a light-emitting element for emitting and irradiating light onto corresponding one or more zones on the test carrier; and a sloping surface for blocking the light mirror-reflected from the non-test carrier from being irradiated onto a photodetector. In one embodiment, the device includes the photodetector for receiving the light reflected or transmitted from the corresponding zones of the test carrier.

In one preferred embodiment, the device further includes a light-blocking element for blocking the light mirror-reflected by the test carrier from being irradiated onto the photodetector. The sloping surface is positioned below the test carrier and is positioned at the top left of the light-blocking element. In one preferred embodiment, the angle formed by the sloping surface and the light which is emitted by the light-emitting element and is escaped from being blocked by the light-blocking element is larger than or equal to 90 degree.

In one embodiment,

$$arc tan \frac{s 3}{s 2} + arctan \frac{s 3 + s 4 - s7}{s 1} \leq {90}^{0} ,$$

where S3 represents the vertical distance between the light-blocking element 12 and the light emitting element 5; S1 represents the vertical distance between the light-emitting element and the window or the test carrier; S2 represents the vertical height of the light-blocking element 12; S4 represents the vertical distance between a crossing point E and the light-blocking element 12, where the crossing point E is formed by the extended line of the sloping surface and the plane where the light-emitting element and the photodetector lie.

### BRIEF DESCRIPTION OF THE DRAWINGS

FIG. 1 is a front sectional view of the reading structure according to one embodiment of the present invention;

FIG. 2 is a schematically sectional view showing the position relationship of the test carrier or the window, the light-emitting element, and a light-blocking element in a reading device according to one embodiment;

FIG. 3 is a stereo schematic diagram of the test carrier or the window, the light-emitting element and the light-blocking element shown in FIG. 2;

FIG. 4 shows the position relationship of the sloping surface for blocking the light reflected from a non-carrier surface with the light-emitting element, the window or the test carrier, the light-blocking element and the photodetector.

FIG. 5 is a schematic view showing the influence of different angles formed by the sloping surface and the light remained after the light emitted by the light-emitting element is blocked on the photodetector; and

FIG. 6 shows the structural view for the surface of the testing zones viewed under an electronic microscope when the testing zones are nitrocellulose membrane.

### REFERENCE SIGNS

Light-emitting element 5
photodetector 7
light-blocking element 12
test carrier 3
liquid surface 2
testing zone 4
window 10
sloping surface 20
micropores of nitrocellulose membrane 40

### DETAILED DESCRIPTION OF EMBODIMENTS OF THE INVENTION

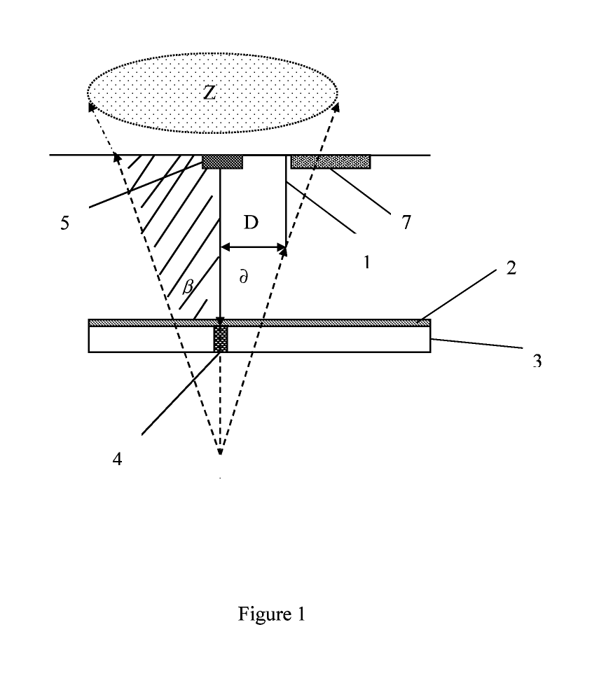

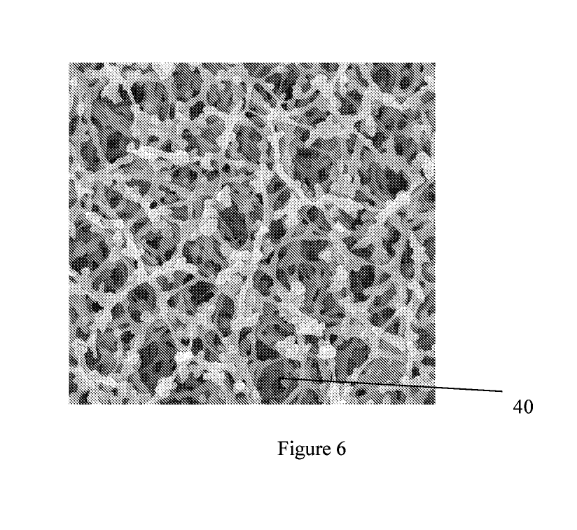

Our studies showed that, as shown in FIG. 1, when a fluid sample is not applied on a test carrier, the surface of the test carrier has a porous structure, and is not a level plane at microscopic level. For instance, as shown by the structure of nitrocellulose membrane under an electronic microscope by a magnification of 1500 in FIG. 6, there are micropores 40 of different sizes on the membrane. When the light-emitting element 5 emits and irradiates light on the carrier, once the flowing of a liquid on the carrier spontaneously forms a very thin liquid surface 2 on the surface of the carrier, which can cover partial or whole surface of the carrier, part of the light from the light-emitting element is mirror-reflected by the liquid surface 2, while the other is transmitted through the liquid surface, irradiated onto specific zones of the test carrier 3 (for example, testing zone 4, one or more of the reference zone or control zone), and absorbed by these specific zones (for example, testing zones) and incurs diffusion. Furthermore, when no liquid flows through the carrier, part of the light is mirror-reflected by the surface of the carrier, the amount of which is small but still present. Besides the possible mirror reflection on the test carrier, it is possible to form mirror reflection on any place which is irradiated directly or indirectly (the emitted light being reflected by many times) by the light from the light-emitting element in other parts of the device.

In fact, detecting the variation of the diffuse reflection on the test carrier can accurately reflect the variation of the test carrier or the result on the test carrier (for example, the variation of color on the testing zones and/or control zone, accumulation of the labeled particulates, the accumulation of the color materials, etc.), while the mirror reflection can hardly reflect the variation of the concentration of the analyte (for example, HCG, LH) in the testing liquid sample. These mirror reflections actually irrelevant with the variation of the signals on specific zones of the test carrier is possible to be detected by the photodetector and result in interference with the final reading results.

Therefore, when designing such reading devices, the photodetector should receive the light diffuse-reflected from the test carrier as much as possible, but not receive the mirror-reflected light. The zones on the test carrier can be one or more of the testing zone, reference zone or control zone. Further, generally, the liquid is sequentially moved from the testing zone to the control zone, or from the testing zone to the reference zone and then to the control zone. Therefore, the liquid surface on the carrier is sequentially formed. Even if no analyte exists in the sample and only the liquid flows, the values of respective zones read by the optical system at the same time will be different due to the difference in time when the mirror reflection occurs in respective zones. Therefore, if the influence of the light mirror-reflected from the test carrier on the photodetector is eliminated in the beginning, the test results obtained in respective zones can be more normalized.

A description will be given below in combination with the drawing on how to prevent a photodetector from receiving undesired light, for example, mirror-reflected light, when reading the assay results on the test carrier. For example, in FIG. 1, when the light-emitting element 5 emits and irradiates light onto a test carrier 3, part of the light is mirror-reflected by the test carrier 3, where b is the mirror image of the light-emitting element. Therefore, the zone on which the mirror reflection occurs is the zone indicated by the angles β and ∂. If viewed from stereo structure, the light emitted from mirror image b point forms a circular z zone in the plane on which the light-emitting element and the photodetector are positioned, where the z zone is the mirror reflected zone. Of course, if the test carriers have different shapes, the shapes of the z zones will be different, and will change with the change of shapes of the zones on the test carrier irradiated by the light.

Further, the device can include a window 10, to which the zones of the test carrier are adjacent. The window serves to define the size and shape of the zone on the test carrier irradiated by the light from the light-emitting element. For example, if the window is in circular or rectangular shape, then the zone on the test carrier irradiated by the light will be circular or rectangular. If the photodetector 7 is arranged in the zone that can be irradiated by mirror reflection (for example, z, β or ∂ zone), the mirror-reflected light can be detected, interfering with the reading results. In order to prevent the mirror-reflected light from being irradiated onto the photodetector, some light-blocking elements are arranged in the mirror-reflected zones such as z, β or ∂ zone, for blocking the mirror-reflected light from irradiating onto the photodetector. Preferably, the light-blocking element is disposed between the light-emitting element and the photodetector. More preferably, the light-blocking element 1 can be disposed for example between the light-emitting element 5 and the photodetector 7 at a certain height and of a certain distance from the light-emitting element. It is also possible that the light-blocking element 12 can be disposed between the light-emitting element 5 and the photodetector at a certain height, and of a distance D from the light-emitting element, so that the light mirror-reflected from the test carrier can be completely blocked from irradiating onto the photodetector. In practical product design, for the purpose of more impact and small-sized reading devices, the distance between the light-emitting element and the photodetected should be as short as possible, so as to increase the intense of the light detected by the photodetector, but this usually positions the photodetector in the mirror-reflecting zones of the test carrier. Therefore, the need for a light-blocking element to block the mirror reflection of the test carrier becomes a necessity or one of the preferred solutions.

In different analyzing system, the position relationship between the light-emitting element and the test carrier or the window is varied, which cause the zones formed by the mirror reflection to vary. Therefore, when using a light-blocking element to eliminate the mirror-reflection on the test carrier, mirror-reflection can be avoided by properly selecting the parameters such as the position and/or height of the light-blocking element according to the variation of position. For example, the actual position of the light-blocking element can be determined by the distance between the light emitting element and the window or the test carrier, and the actual size of the window.

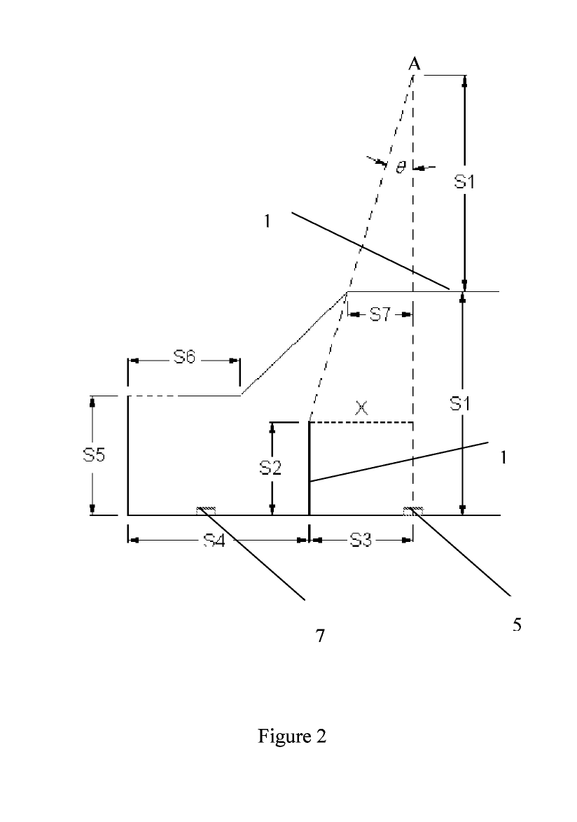

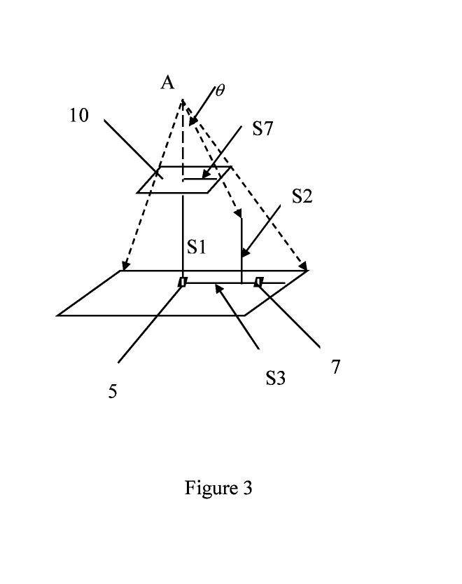

For example, in FIGS. 2-3, the vertical distance of the light-emitting device from the testing window 10 is S1, the length of the window is S7, the test carrier is close to the window so that the zones on the carrier are irradiated by the light-emitting element, and the distance between the test carrier and the window as well as the thickness of the window can be ignored. The size of the window can limit the area of zones on the test carrier irradiated by the light from the light-emitting element. Of course, it can be considered that the vertical distance of the light-emitting device from the testing carrier 3 is S1, and the length of the light zone on the test carrier that can be irradiated by light is S7. Point A represents the mirror image of the light-emitting element relative to the window or the test carrier.

Assuming that point A, the position of the light-emitting element and the position of the light-blocking element are on the same plane, the light emitted from the light-emitting element and irradiated onto the test carrier or the window forms a mirror-reflection zone within the θ angle. In order to completely block light mirror-reflected by the test carrier from irradiating onto the photodetector, a light-blocking element 12 is arranged therebetween to block mirror reflection. In this case, the vertical distance S3 (X) between the light-blocking element 12 and the light-emitting element 5 is a function of the distance S1 between the light-emitting element and the window or the test carrier, and the length S7 of the window. The function is as follows:

$$tan θ = \frac{s 7}{s 1} ;$$

$$tan θ = \frac{x}{2 \times s 1 - s 2}$$

$$x = tan θ \times ( 2 \times s 1 - s 2 ) \to x = \frac{s 7}{s 1} \times ( 2 \times s 1 - s 2 ) ;$$

For the purpose of completely blocking the mirror reflection from the test carrier, it is necessary to meet s3≧x; so it can be deduced:

$$s 3 \geq \frac{s 7}{s 1} \times ( 2 \times s 1 - s 2 ) .$$

According to the above function, in designing a product, when some of the parameters are determined, the varying range of the position relationship between the other elements can be calculated, thus shortening the development cycle of the product.

More preferably, in order that the diffuse reflection from the test carrier can be detected by the photodetector, the vertical height S2 of the light-blocking element is smaller than the distance S1 of the light-emitting element from the test carrier or the window, that is, s2<s1.

The position relationships between these elements are calculated as an example. In a stereo structure, the positions of the light-emitting element, the light-blocking element, and the photodetector are sometimes not on the same plane. Then they can be projected on one plane and the position function thereof can be calculated according to the above method. Here the parameters (S3, S1 and S2) refer to the vertical distances between their projections on the same plane. Generally, the light-blocking element and/or the photodetector can be projected onto the plane on which the line formed by the light-emitting element and the mirror image thereof and any of the mirror-reflected light lie, and the function therebetween can be calculated.

On the other hand, the light-blocking element can block the light mirror-reflected by the test carrier from irradiating onto the photodetector. However, in addition to the light irradiated onto the test carrier, part of the light from the light-emitting element is irradiated onto other elements of the device, so that the light mirror-reflected or multi-reflected from other elements can be detected by the photodetector, consisting in undesired light for the photodetector and adversely affecting the final reading results.

In view of this, a sloping structure 20 (or other blocking structure) is designed to prevent or avoid the light emitted from the light-emitting element and reflected from other elements of the device (non-test carrier) from being irradiated on the photodetector. By using the blocking-structure at a certain angle with the light from the light-emitting element, the reflected or multi-reflected light can be prevented from being irradiated onto the photodetector, thereby reducing the interference of the undesired light and providing more accurate assay result for the test carrier. Therefore, in one particular embodiment, the present invention provides a device for reading the test result on a test carrier, including: a light-emitting element, for emitting and irradiating light onto corresponding one or more zones of the test carrier; and a sloping surface, blocking the light mirror-reflected by non-test carrier from being irradiated onto the photodetector. In one embodiment, the device includes a photodetector, for receiving the light reflected or transmitted from the zones of the test carrier. The sloping structure can block the light that is emitted from the light-emitting element and is not directly irradiated onto the test carrier within the zones where the light-emitting element lies, rather than entering the zones where the photodetector lies and being detected by the photodetector. Such detection can be receiving the light directly from the light-emitting element, or receiving the light emitted from the light-emitting element and reflected by the sloping surface, or receiving the light emitted from the light-emitting element, reflected by the sloping surface and multi-reflected by other elements. The sloping surface can be positioned below the window, and at the top-left of the light-blocking element.

By combining with the light-blocking element for blocking the light mirror-reflected by the test carrier from entering the photodetector as disclosed above, all the mirror-reflected light can be prevented from entering the photodetector, and thus the interference of undesired light can be prevented when reading the assay results on the testing element by using an electro-optical system. In other words, only part of the diffuse-reflected light that actually reflect the variation of testing signals on the test carrier is detected by the photodetector, thus avoiding the interference of undesired light. Here the light-blocking element and the sloping surface can be collectively referred as a blocking element.

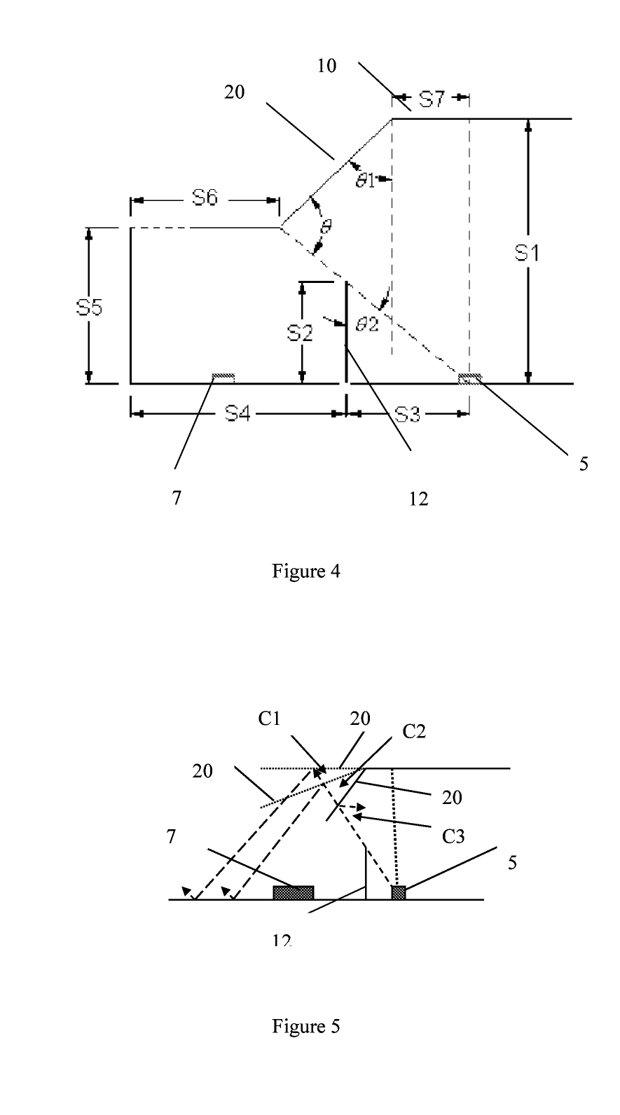

As shown in FIGS. 4-5, when a light-blocking element 12 is arranged between the photodetector and the light-emitting element, part of the light from the light-emitting element 5 can be irradiated onto the zones of non-test carrier, for example, the sloping surface 20. In order to prevent undesired light from entering the photodetector, the angle of the sloping surface should be set, so that the angle formed by the sloping surface 20 with the light escaped after the light emitted from the light-emitting element is blocked by the light-blocking element is larger than or equal to 90° (FIG. 5), then the undesired light can not enter the zone of the photodetector 7. For example, in FIG. 5, when the angle between the sloping surface 20 and light from the light-emitting element 5 is C1 (the angle between the sloping surface and the plane where the window lies is 180°) or C2 (the angle between the sloping surface and the plane where the window is an obtuse angle), and C1 and C2 are acute angles, the light may enter the zone where the photodetector 7 lies and be multi-reflected and detected by the photodetector. The interference of the light to the photodetector finally results in the interference to the read test results. When the angle between the sloping surface 20 and the light from the light-emitting element is C3 which is larger than or equal to 90°, almost all the light from the sloping surface 20 does not enter the zone where the photodetector lies. In this case, the sloping surface 20 lies below the window and at the top-left of the light-blocking element.

As shown in FIG. 4, in order to make the angle (θ≧=90°) formed by the sloping surface 20 and the light emitted from the light-emitting element 5 larger than or equal to 90°, the position relationship using the following parameters should be considered: θ1+θ2+θ=180°, therefore: θ1+θ2≦90°; while

$$tan θ = \frac{s 3}{s 2} ;$$

$$tan θ 1 = \frac{s 3 + s 4 - s 7}{s 1} \to θ 2 = arctan \frac{s 3}{s 2} ;$$

$$θ1 = arctan \frac{s 3 + s 4 - s 7}{s 1} , \\ therefore \text{:} arctan \frac{s 3}{s 2} + arctan \frac{s 3 + s 4 - s 7}{s 1} \leq {90}^{0} ,$$

where S3 represents the vertical distance between the light-blocking element 12 and the light-emitting element 5; S1 represents the vertical distance between the light-emitting element and the window or the test carrier; S7 represents the length of the window or the length of the light zone irradiated onto the carrier; S2 represent the vertical height of the light-blocking element 12; S4 represents the vertical distance between the crossing point E, which is formed by the extended line of the sloping surface 20 and the plane where the light-emitting element, the photodetector lie, and the light-blocking element 12.

More preferably, in order that the diffuse reflection from the test carrier can be detected by the photodetector, the vertical distance between the top point of the light-blocking element and the sloping surface should be at least larger than zero.

The test carrier described in the present invention includes the test strip, the lateral-flow immunoassay device, the lateral-flow assay test strip, and the porous carrier disclosed in Chinese Patent No. 200910126658.3. The test carrier further includes the test strip disclosed in European Patent EP291194. Furthermore, the device for reading assay results disclosed in the present invention can further include an optical reading system, which was described in details in Chinese Application No. 200910126658.3 or 200410063910.0 filed on Jun. 4, 2004. Each of the particular embodiments disclosed in these published literatures can be combined with the embodiments in the present invention to consist in the embodiments of the present invention, and thus become a part of the present invention.

In practice, if the signal to be measured and analyzed exceeds an upper limit or is lower than a lower limit, the device for reading assay results of the present invention can include a system for reporting the results before finishing the analysis. Such a system is described in details in U.S. patent application Ser. No. 10/741,416, filed on Dec. 19, 2003. Each of the particular embodiments disclosed in the literature can be combined with these disclosed in the present invention to consist in the embodiments of the present invention, and become a part of the present invention.

The device for reading assay results disclosed in the present invention can further includes a system for detecting flowing speed of the fluid sample or the time needed for the fluid sample to pass the test carrier. Such a system is described in details in U.S. patent application Ser. No. 10/742,456, filed on Dec. 19, 2003. Each of the particular embodiments disclosed in the literature can be combined with these disclosed in the present invention to consist in the embodiments of the present invention, and become a part of the present invention.

1. A device for reading an assay test result on a test carrier, comprising:
a light-emitting element, for emitting and irradiating light onto corresponding one or more zones of the test carrier; and
a light-blocking element, for blocking the light mirror-reflected by the test carrier from being irradiated on a photodetector.

2. The device according to claim 1, wherein the device further comprises a window through which the light emitted from the light-emitting element is irradiated onto the test carrier.

3. The device according to claim 2, wherein positions of the light-emitting element, the light-blocking element and the window meet a function of S3≧2×S7−S7×S2÷S1, where S1 represents a vertical distance between the light-emitting element and the window; S2 represents a vertical height of the light-blocking element; S3 represents a vertical distance between the light-blocking element and the light-emitting element; and S7 represents a length of the window.

4. The device according to claim 3, wherein the positions of the light-emitting element, the light-blocking element and the window meet a function of S3=2×S7−S7×S2÷S1.

5. A device for reading a test result on a test carrier, comprising:
a test carrier comprising one or more zones;
a light-emitting element, for emitting and irradiating light onto corresponding one or more zones of the test carrier;
a photodetector, for receiving the light from the one or more zones on the test carrier; and
a light-blocking element, for blocking the light mirror-reflected by the test carrier from being irradiated onto the photodetector.

6. The device according to claim 5, wherein positions of the light-emitting element, the light-blocking element and the window meet a function of S3≧2×S7−S7×S2÷S1, where S1 represents a vertical distance between the light-emitting element and the one or more zones of the test carrier; S2 represents a vertical height of the light-blocking element; S3 represents a vertical distance between the light-blocking element and the light-emitting element; and S7 represents a length of a light zone on the test carrier irradiated by the light from the light-emitting element.

7. The device according to claim 5, wherein the positions of the light-emitting element, the light-blocking element and the window meet a function of S3=2×S7−S7×S2÷S1.

8. The device according to claim 1 or 5, wherein the light-blocking element is positioned in an area where mirror reflection is occurred in the one or more zones of the test carrier.

9. The device according to claim 1 or 5, wherein a vertical height of the light-blocking element is smaller than a vertical distance of the light-emitting element from the test carrier or the window.

10. The device according to any one of claims 1-9, wherein the light-blocking element blocks the light mirror-reflected by a liquid surface on the test carrier from irradiating onto the photodetector.

11. The device according to any one of claims 1-9, wherein the carrier is a porous carrier.
